(19) United States
(12) Patent Application Publication
(10) Pub. No.: US 2002/0104864 A1
(43) Pub. Date: Aug. 8, 2002

(54) Method and device for fracture-splitting a machine component with bearing eye

(76) Inventors: Gunter Knoll, Wernstein (AT); Andreas Kalman, Pocking (DE)

Correspondence Address: Rosenman & Colin, 15th Floor, 575 Madison Avenue, New York, NY, 10022-2585, US

(21) Appl. No.: 09/980,554

(22) PCT Filed: Mar. 2, 2001
(86) PCT No.: PCT/EP01/02370

(30) Foreign Application Priority Data
Mar. 21, 2000 (DE) 100 13 980.9

(51) Int. Cl. B26F 3/00

(52) U.S. Cl. 225/2; 225/103

(57) ABSTRACT

A method for cleaving a conrod (1) of a reciprocating-piston engine into two bearing shells each comprising one half of the bearing eye (2) has the following steps: before the breaking process, the machine component is stuck with its bearing eye (2) onto a two-piece split mandrel (10); the bearing eye is subjected to initial stress in splitting direction, by forcing the two mandrel halves (11, 12) apart; the bearing eye (2) is positionally fixed, relative to the associated mandrel half (11), on one side of the intended splitting plane (4) by means of adjustable stops (29); by driving in a wedge (16) between the two mandrel halves (11, 12), the positionally fixed bearing shell together with the associated mandrel half (11) is split from the bearing shell fixed on the other mandrel half (12) by substantially simultaneous breaking of both sides.

The invention relates to a method for cleaving a machine component having a bearing eye, especially a conrod of a reciprocating-piston engine, into two bearing shells each comprising one half of the bearing eye, as well as a device for the purpose.

In U.S. Pat. No. 1,630,759, which relates to the cleaving of hollow cylindrical workpieces such as bearing shells and bushings, it is described that, upon initiation of the splitting process by means of a wedge, the two sides of the workpiece break one after the other and that a hinging action therefore takes place about the side last to break. Such a hinging action usually leads to permanent deformation, with the result that the two fragments no longer fit exactly together. This disadvantage becomes particularly serious if the workpiece was already finish-machined before the breaking process.

The means used to break the hollow cylindrical workpiece comprises a two-piece mandrel which fills the interior of the workpiece, a wedge being driven in between the mandrel pieces. Two spring elements bearing on the outside of the workpiece are clamped together against compression springs by means of tensioning bolts.

The placement of spring elements on the outside circumference of the workpiece is supposed to produce a uniform distribution of breaking forces while the workpiece is being snapped into two fragments, and so deformation of the fragments is prevented even if the two sides break consecutively.

The premise of European Patent B1 0167320 is also that, in a machine component having a bearing eye, the two bearing sides break consecutively during cleaving by means of a wedge, whereby undesired deformations are possible. Such deformations are supposedly reduced by a two-stage splitting process, in which the bearing branches of the first side to break are clamped together once again, after which the other side is broken. To reduce the breaking forces and to achieve fracture surfaces that are as even as possible, it may be expedient to make the workpiece from a brittle material or to transform the workpiece temporarily to a condition with low breaking resistance, for example by cooling to low temperature. In this sense it may also be expedient to provide the workpiece on the inside of the bearing eye with grooves, notches, rows of holes or the like running along the subsequent fracture plane, in order to weaken the fracture cross section or to facilitate the initiation of fracture.

A comparable method for cleaving of conrods for reciprocating-piston engines is described in European Patent B1 0304162. In this case the bearing eye is clamped together perpendicular to the fracture plane by means of clamping jaws against a split mandrel provided in the interior of the bearing eye. This clamping of the two halves of the bearing eye is maintained even after cleaving by means of a wedge, the two bearing sides breaking consecutively within a short time interval. By the fact that this clamping of the bearing halves between the associated mandrel halves and the corresponding clamping jaws is maintained, the fragments are supposedly moved away from one another in as linearly a manner as possible after the splitting process, and so detrimental deformation of the two bearing halves in the region of the lateral bearing branches adjacent to the fracture surface is prevented. Immediately after cleaving, the two mandrel halves, together with the conrod fragments clamped thereto, on the one hand the big-end cap and on the other hand the conrod shank, are moved apart from one another on slide guides, after which the clamps are released and the conrod fragments can be removed.

According to another method, known from German Patent C2 4037429, for cleaving a conrod, the two bearing halves are pulled away from one another perpendicular to the subsequent splitting plane by means of a press, each bearing half being placed without clamps against the associated half of an internal mandrel by means of stops bearing in splitting direction and perpendicular thereto, and the small-end eye of the conrod being braced only laterally. In this process the bearing half which is joined to the conrod shank and is movable on a slide is snapped off from the other bearing half, which is disposed in a manner fixed to the frame. The two bearing shells remain substantially aligned with one another during the cleaving process, and so the occurrence of secondary bending in the region of the bearing eye, with the possible consequence of undesired deformations, is greatly diminished.

Finally, a method for making breakable conrods is described in European Patent A2 0507519, according to which method the two halves of the bearing eye can be split away from one another by application of controlled breaking forces. For this purpose, the mandrel halves disposed in the inside of the bearing eye are forced apart from one another by moving the mandrel half associated with the big-end cap away from the other mandrel half, thus creating a tensile stress in the bearing eye, until it breaks. During cracking, the conrod is guided only perpendicular to the splitting direction, by springs and between stops; moreover, the big-end cap is braced compliantly against the splitting direction; finally, the small-end eye is held with lateral play in a stop block, so that it can perform lateral compensating movements during cracking. In this way, macroscopic hinging actions of the two broken parts during cracking are intentionally tolerated. Because of the limited lateral compensating movement of the small-end eye as explained in the foregoing, permanent deformations of the two bearing-shell halves are supposedly prevented.

In contrast, the object of the present invention is to prevent undesired deformations of the two bearing-shell halves in the region of the fracture surfaces, even under the effect of large breaking force, when a breaking wedge is used to achieve cleaving; thus the cleaving method should also be usable for making conrods from materials with relatively high breaking rigidity.

This object is achieved by the inventive method comprising the steps according to claim 1. For the purpose, there is used a two-piece split mandrel according to European Patent B1 0304162, onto which the bearing eye is stuck.

In a departure from the known method, an initial stress in splitting direction is applied to the bearing eye by forcing the two mandrel halves apart in a manner similar to the method described in European Patent A2 0507519, which relates to a method in which the two mandrel halves are forced apart not by hammering in a wedge, but slowly and gradually by hydraulic forces. Under these conditions, however, the risk exists that the resulting fracture surfaces will be skewed.

By the fact that, in the present invention, the bearing eye is fixed in position by means of adjustable stops only on one side of the intended splitting plane, the other side can undergo small hinging actions without secondary bending during breaking, and so permanent deformations are prevented. For this purpose it is essential that the positional fixation is not merely elastic in nature, but instead that the corresponding side of the bearing eye be fixed such that no play is possible. In this respect the present invention differs from European Patent A2 0507519, where the bearing half joined to the conrod shank is indeed also braced with play in the region of the small-end eye, but the big-end cap is braced only by compliant retaining forces. Consequently, substantially simultaneous breaking of both sides of the bearing eye cannot be achieved in the known method. Such simultaneous breaking, however, is an important prerequisite for ensuring that approximately equal breaking forces occur on both sides of the bearing eye, so that permanent deformations due to loads beyond the yield point of the conrod material can already be reliably prevented. Thus the degree of deformation is largely independent of the magnitude of the breaking forces involved.

During breaking in the inventive method, the mandrel half associated with the positionally fixed bearing shell is expediently moved away from the other mandrel half, which is fixed to the frame. Thus, while the bearing shell fixed without play is braced movably, for example on a slide, the bearing shell disposed such that it is fixed to the frame permits the bracing with limited play that is desired to compensate for macroscopic hinging actions.

If the breaking forces must be kept small, it may be expedient to provide grooves running along the splitting plane on the inside of the bearing eye or similar measures to reduce the breaking resistance. Instead of grooves, it is possible within the scope of the invention to provide a plurality of holes arrayed along a line, such as fine laser-drilled holes, which additionally have the advantage that they cause local embrittlement of the material and, furthermore, if they are made in the form of holes with conical shape, they achieve the effect of typical breaking notches.

A suitable device for performing the inventive method is designed according to claim 4. Therein there is provided a two-piece split mandrel, whose circumference corresponds approximately to the bore of the bearing eye. The two mandrel halves adjoin one another with plane faces, which together define a recess for hammering in a wedge-driving tool, the recess preferably being formed in the movable mandrel half as a slanted face matched to the wedge-driving tool, whereas in the mandrel half fixed to the frame the recess has constant cross section throughout.

Because of the wedge impact, the mandrel halves are snapped apart, the mandrel half associated with the conrod shank being disposed such that it is fixed to the frame, while the other is attached to a slide arrangement, so that after the cleaving process it travels a distance of 8 to 10 mm together with the slide.

In contrast to the mandrel half disposed on the slide arrangement, the big-end cap is positionally fixed by means of two stops, the stops bearing without play against the shoulders on both sides of the conrod, or in other words via the entries of the bolt holes of the conrod. To protect the bolt holes, and also for the purpose of better pressure distribution in the region of the stop faces, it is provided in one embodiment of the invention that the stops are mounted on spherical cups, so that their plane stop faces can be oriented flush with the mating faces of the conrod end at any angular position thereof.

Positional fixation of the cap without play is achieved by the fact that the stops can indeed be brought into position hydraulically, but after being positioned are blocked against slipping out in splitting direction by means of a mechanical correcting device. This mechanical correcting device is preferably designed as a wedge-type deflector that can be actuated by means of a hydraulic prop having the form of a hydraulically actuated piston-cylinder arrangement.

During the entire breaking process, the positional fixation of the big-end cap is maintained without relaxation; it is released only when the big-end cap is removed after full travel of the slide. For this purpose, the hydraulic prop of the mechanical correcting device is depressurized or retracted, whereupon the piston that is controlled by the wedge-type deflector and actuates the stop is moved correspondingly in splitting direction.

The two stops are expediently returned to the positionally fixed stop position only after the bearing eye of the next conrod to be machined is again under initial stress, the slide arrangement ensuring that the bearing eye is subjected to an initial tensile stress supported by the two mandrel halves before the breaking process. For this purpose, the slide arrangement is subjected by means of a hydraulic piston-cylinder arrangement to initial stress, against the frame of the device, in the splitting direction. The half of the bearing eye joined to the conrod shank is fixed with play between the mandrel half fixed to the frame on the one hand and a pin retainer which engages in the inside of the small-end eye on the other hand. This pin retainer is advantageously a diagonal pin, which engages with play in the small-end eye, so that this cannot slip out laterally relative to the longitudinal direction of the shank but is nevertheless mounted with play in the longitudinal direction of the shank.

According to a further embodiment, the slide arrangement can be displaced against a compression spring disposed between it and the frame, in order to arrest the slide arrangement at the end of its outward travel movement after it has been thrown off by the breaking process.

It is advantageous to associate the mandrel half fixed to the frame with the big-end bearing which includes the conrod shank. In this way the slide construction is simplified; moreover, exact adjustment of the permissible movement play is possible because of the lever effect in bracing the small end. If these advantages are not employed, it is also possible to dispose the conrod in inverted manner with respect to the two mandrel halves, in which case the big-end cap would be associated with the stationary mandrel half.

A practical example of the invention will be explained hereinafter with reference to the drawing, wherein:

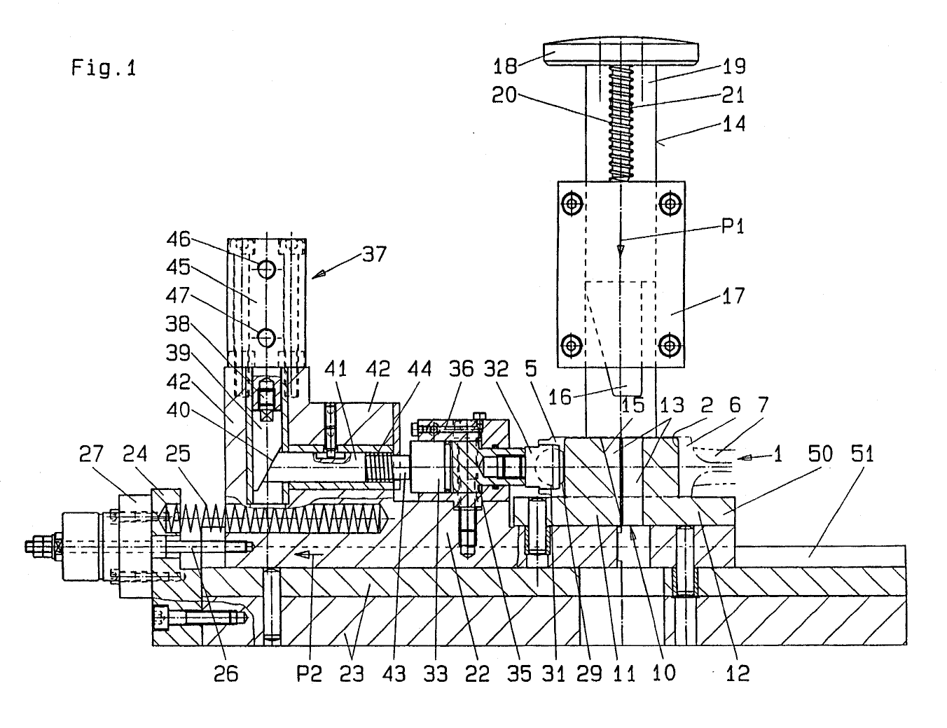

FIG. 1 shows a partly cutaway side view of the splitting device and

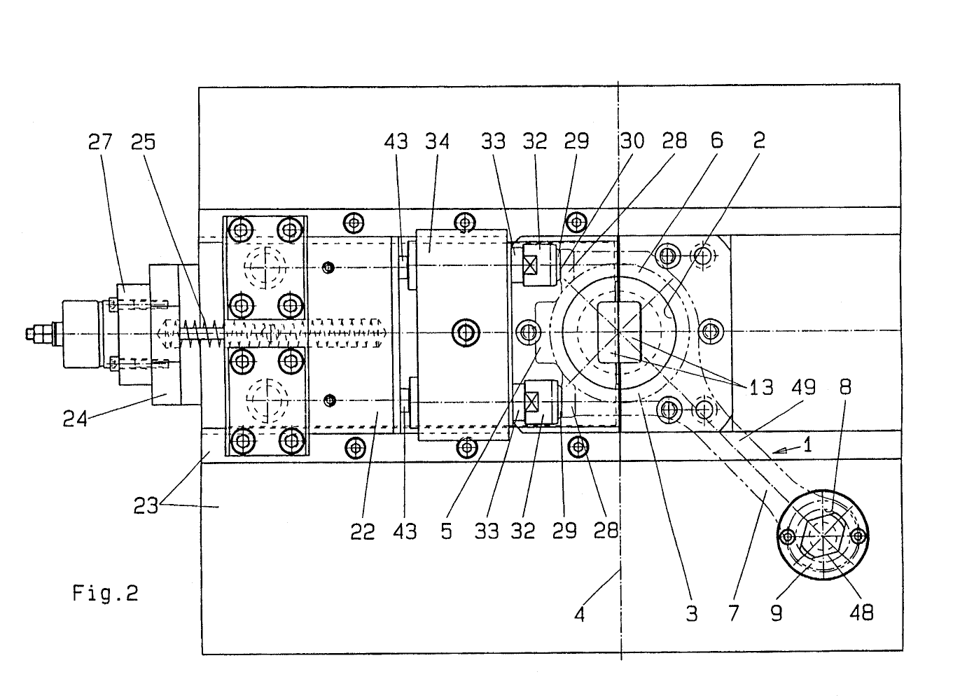

FIG. 2 shows a top view of the device according to FIG. 1.

In the device for cleaving a machine component having a bearing eye according to FIGS. 1 and 2, a conrod 1 of a reciprocating piston engine is inserted as the workpiece. Conrod 1 has a bearing eye 2 inside a bearing shell 3, which is to be split into two halves in splitting plane 4 by a controlled break. One half will be formed by big-end cap 5 and the other half by big-end bearing 6, to which the actual shank 7 is joined as a one-piece structure, small-end eye 8 being formed inside small-end bearing 9 at the end of the said shank.

Inside bearing eye 2 there is disposed a split mandrel 10 with a movably supported mandrel half 11 and a mandrel half 12 fixed to the frame. A recess 13 for hammering in a wedge-driving tool 14 adjoins splitting plane 4 between the two mandrel halves 11, 12. Inside movable mandrel half 11, recess 13 is defined by a slanted face 15, which is matched to the wedge angle of wedge-driving tool 14; in the region of mandrel half 12 fixed to the frame, recess 13 is formed continuously with constant rectangular cross section.

Wedge-driving tool 14 is disposed centrally above mandrel 10 in such a way that a splitting wedge 16 at the lower end of wedge-driving tool 14, which is guided in a guide block 17, is hammered into recess 13 in the direction of arrow PI when a blow is applied by a press (not shown) to an anvil 18 at the upper end of wedge-driving tool 14. Between anvil 18 and guide block 17 there are disposed on guide rods 21 compression springs 20, one on each side of a plunger 19 of wedge-driving tool 14. Compression springs 20 ensure that plunger 19 travels back to its upper starting position shown in FIG. 1 after the wedge has been hammered in and the wedge-driving tool has been released by the press.

Movable mandrel half 11 is attached to a slide 22, which in turn is mounted in horizontally movable manner on a frame 23. Between slide 22 and an end piece 24 of frame 23 there is braced a compression spring 25, which cushions the slide before it reaches its left end position. Slide 22 is thrown to this end position as a result of the wedge impact which causes conrod 1 to break. The resulting travel of the slide is only 8 to 10 mm. Slide 22, which is thrown in splitting direction represented by arrow P2, is joined via a hydraulic piston 26 to a hydraulic cylinder 27, which is attached to the outside of end piece 24 of frame 23. Hydraulic cylinder arrangement 26, 27 functions to apply initial stress to slide 22 in the splitting direction indicated by arrow P2, whereupon mandrel half 11 attached to the slide transfers a breaking force corresponding to this initial stress to conrod eye 2, which is fixed by mandrel half 12 fixed to the frame. Mandrel half 12 fixed to the frame is joined with its base 50 firmly to a mounting plate 51, which in turn is attached to frame 23 of the device. In this way a corresponding initial tensile stress in splitting direction is produced in bearing shell 3 of conrod 1 before the wedge impact that causes breaking is applied. The return movement of slide 22 after the wedge impact is then ensured by compression spring 25.

After application of initial stress to bearing eye 2 of conrod 1, bearing shell 3 is positionally fixed in the region of big-end cap 5 to be produced later, namely after the breaking process, by means of two stops 29 bearing on opposite shoulders 28 of conrod 1. Stops 29 have plane stop faces 30, which by means of spherical cups 31 provided thereon are mounted with limited ability to move in corresponding stop housings 32. Stop housings 32 are screwed into a piston element 33, which is held in a cylindrical bore of a cylinder housing 34. Piston element 33 and cylindrical bore 34 have a step 35, which is connected to a compressed-air inlet 36. The latter functions to retract stop 29 from its stop position, in order to release big-end cap 5 for removal. Retraction of stop 29 is possible only after a mechanical catch has been lifted by a mechanical correcting device 37, which is designed as a wedge-type deflector, which can be actuated by a hydraulic prop 38 in the form of a hydraulic piston-cylinder arrangement. The wedge-type deflector comprises a vertical piston 39, which adjoins a horizontal piston 41 via a common wedge face 40. Horizontal piston 41 ends outside housing 42 of correcting device 37 accommodating it at a piston end 43, which is turned down to smaller diameter. Inside housing 42, horizontal piston 41 is provided with a helical spring 44, which lifts horizontal piston 41 from piston element 33 joined to stop 29 and pushes the horizontal piston backward. Thus helical spring 44 acts as a compression spring, which has the tendency to urge piston end 43 into the interior of housing 42. At the upper end, correcting device 37 has a port housing 45 with a hydraulic port 46 for actuation of vertical piston 39 downward and a hydraulic port 47 for actuation thereof upward.

To apply stop 29, vertical piston 39 is driven downward and accordingly acts via wedge face 40 to move horizontal piston 41 to the right, or in other words counter to the splitting direction according to P2. Thus piston end 43 travels out of housing 42, strikes piston element 33 of stop 29 and urges the said stop against the corresponding stop face on shoulder 28 of big-end cap 5. In this way stop 29 is positionally fixed exactly, or in other words without play, so that it is not under initial stress. When the stops 29 provided on both sides of bearing shell 3 are in their stop position, they hold the associated half of bearing shell 3 of conrod 1 in corresponding stop position against mandrel half 11 joined to slide 22. In principle this stop position is not changed in any way by the cleaving action caused by the wedge impact. In other words, it is maintained in unchanged condition while slide 22 is traveling away in the splitting direction indicated by arrow 2 after the cleaving process has been performed. It is only for removal of big-end cap 5 that hydraulic prop 38 is reversed in order to travel upward and release the path for horizontal return movement of horizontal piston 41 of correcting device 7 to the left. This retraction of horizontal piston 41 is assisted by compression spring 44 seated at its end. In this way piston end 43 of horizontal piston 41 releases piston element 33 of stop 29; thereafter stop 29 can be lifted from the mating face on shoulder 28 of conrod 1 by means of compressed air via compressed-air inlet 36, after which removal of big-end cap 5 becomes possible.

On the other hand, big-end bearing 6 is seated loosely on mandrel half 12 fixed to the frame, and so it can be lifted off at any time. This action is not hindered by a transverse pin 48, over which small-end eye 8 is placed, since small-end eye 8 of small-end bearing 9 accommodates transverse pin 48 with little play, such that it is substantially fixed in a direction perpendicular to axis 49 of conrod shank 7, whereas it is held with play in the longitudinal direction thereof. In this way, big-end bearing 6 is secured against hinging action during the cleaving process, whereas it can yield to a limited extent in the direction of conrod shank 7 under the breaking forces produced, so that secondary bending and thus peaks of breaking force are largely avoided during the cleaving process.

By the fact that an initial stress in the splitting direction indicated by arrow P2 is imposed on bearing eye 2 before th e cleaving process, the wedge impact acts on bearing shell 3 for only a very short time, and so both sides of bearing shell 3 break almost simultaneously. At worst, this breaking of the two bearing sides takes place in such a short time interval that the human ear can distinguish only one continuous splitting sound.

A further essential prerequisite for simultaneous splitting of the two bearing sides is that only one bearing half, in the present case big-end cap 5, be positionally fixed, whereas the other half, in the present case big-end bearing 6, be held with small play. As a result, the two bearing sides are broken with breaking forces of substantially equal magnitude. By the fact that movable mandrel half 11 is fixed without play, unfavorable hinging actions are prevented during the cracking process, as are therefore undesired permanent deformations of the two halves of the bearing shell relative to one another.

1. A method for cleaving a machine component having a bearing eye (2), especially a conrod (1) of a reciprocating-piston engine, into two bearing shells each comprising one half of the bearing eye (2), with the following steps:
1.1 before the breaking process, the machine component is stuck with its bearing eye (2) onto a two-piece split mandrel (10);
1.2 the bearing eye is subjected to initial stress in splitting direction, by forcing the two mandrel halves (11, 12) apart;
1.3 the bearing eye (2) is positionally fixed, relative to the associated mandrel half (11), on one side of the intended splitting plane (4) by means of adjustable stops (29);
1.4 by driving in a wedge (16) between the two mandrel halves (11, 12), the positionally fixed bearing shell together with the associated mandrel half (11) is split from the bearing shell fixed on the other mandrel half (12) by substantially simultaneous breaking of both sides.

2. A method according to claim 1 characterized in that, during the breaking process, the mandrel half (11) associated with the positionally fixed bearing shell is moved away from the other mandrel half (12) fixed to the frame.

3. A method according to claim 1 characterized in that, during manufacture of the machine component, the breaking resistance of the bearing eye (2) is weakened on its inside along the intended splitting plane (4).

4. A device for cleaving a machine component having a bearing eye (2), especially a conrod (1) of a reciprocating-piston engine, into two bearing shells each comprising one half of the bearing eye (2), with the following features:
4.1 it comprises a two-piece split mandrel (10), whose mandrel halves (11, 12) form a common recess (13) for driving in a wedge-driving tool (16);
4.2 the circumference of the mandrel corresponds approximately to the bore of the bearing eye (2), the mandrel half (11) associated with the big-end cap (5) being disposed on a slide arrangement (22) which is movable in splitting direction, the other mandrel half (12) being fixed to the frame;
4.3 the slide arrangement (22) supports two stops (29) for positionally fixing the big-end cap (5) relative to the associated mandrel half (11) on both sides without play;
4.4 the conrod shank (6, 7) is fixed between the mandrel half (12) fixed to the frame and a pin retainer in the inside of the small-end eye (8) such that it has limited movement ability;
4.5 the slide arrangement (22) is subjected to initial stress in splitting direction (P2), in such a way that the bearing eye (2) is subjected to an initial tensile stress assisted by the two mandrel halves (11, 12) before the breaking process.

5. A device according to claim 4, that the stops (29) can be hydraulically actuated and in addition are blocked against slipping out in splitting direction (P2) by a mechanical correcting device (37).

6. A device according to claim 5, characterized in that the mechanical correcting device (37) is designed as a wedge-type deflector that can be actuated by means of a hydraulic prop (38).

7. A device according to claim 4, characterized in that the movable mandrel half (11) is rigidly joined to the slide arrangement (22) and in that, by means of a hydraulic cylinder arrangement (26, 27), the latter can be subjected to initial stress in splitting direction (P2) against a base frame (23) of the device.

8. A device according to claim 7, characterized in that the slide arrangement (22) can be subjected to initial stress against a compression spring (25) disposed between slide arrangement (22) and frame (23), such that the slide (22) is cushioned after breaking of the conrod (1).

9. A device according to claim 4, characterized in that the stops (29) are mounted on spherical cups (31), so that plane stop faces (30) can be oriented flush with the mating faces of the conrod end at any angular position thereof.

10. A device according to claim 4, characterized in that the recess (13) in the movable mandrel half (11) is formed as a slanted face (15) matched to the wedge-driving tool (16), and in that the recess (13) in the mandrel half (12) fixed to the frame has constant cross section throughout.

11. A device according to claim 14, characterized in that the small-end eye (8) is fixed with play in the longitudinal direction of the conrod shank (1) by a transverse pin (48) engaging therein.
